(19) United States
(12) Patent Application Publication
(10) Pub. No.: US 2009/0165454 A1
(43) Pub. Date: Jul. 2, 2009

(54) SYSTEM AND METHOD FOR PRODUCING ELECTRICAL POWER FROM WAVES

(76) Inventor: Reuven WEINBERG, Neve Monosson - Yahud (IL)

Correspondence Address: SOROKER-AGMON ADVOCATE AND PATENT ATTORNEYS, NOLTON HOUSE, 14 SHENKAR STREET, HERZELIYA PITUACH, 46725, IL

(21) Appl. No.: 11/967,281

(22) Filed: Dec. 31, 2007

(51) Int. Cl. F03B 13/24

(52) U.S. Cl. 60/497

(57) ABSTRACT

An apparatus and method for converting the motion of a body of water to rotational energy comprising a float, the float is connected to a rigid object, the rigid object is connected to pistons generating pressurized air, a container interconnected to said pistons conveying the pressurized air to said container which is released into the container into flaps formed chambers, said flaps formed chambers are connected to a chain, said chain is connected to tread wheels; wherein the force exerted by the pressurized air on the flaps formed chambers generate movement of the flaps formed chambers.

### BACKGROUND OF THE INVENTION

1. Technical Field

The present disclosure relates to producing electrical power in general, and to a method and apparatus for producing electrical power from waves in particular.

2. Discussion of the Related Art

Producing electrical power from waves generated by the movement of a body of water is known in the art. Some solutions use the movement of objects caused by water or wind to generate power. Mechanisms for converting the movement of such objects into electricity are also known in the art.

One example for such a mechanism is depicted in U.S. Pat. No. 4,931,662 to Burton. Burton discloses a device for generating electrical energy from wave motion. According to Burton there is disclosed a platform connected by pivot and a hydraulic or fluid pump, the pivot is supported by a long beam and the beam is connected at its end to the hydraulic pump. The outer region end of the beam supports a float. The float resonates according to the frequency of the waves, and transfers the motion of the waves to generate electrical power.

Since Burton suggests the use of hydraulic or fluid pump, Burton discloses an inefficient method of converting the motion of the waves into electrical power since the hydraulic fluid within said pump generates resistance therefore limiting the efficiency of the power-generating device disclosed therein.

It is thus required to provide a new apparatus for producing electrical energy from waves using a more efficient method.

### SUMMARY OF THE PRESENT INVENTION

The disclosed subject matter provides for an apparatus for converting the motion of a body of water to rotational energy comprising a float oscillating by the movement of the body of water. The float is connected to a rigid object that is connected to one or more pistons generating pressurized air in one or more air chambers caused by vertical movement of the float. The apparatus further comprises a container partially filled with a fluid and interconnected to said pistons through one or more pipes conveying the pressurized air to said container. The pressurized air is released into one or more flaps formed chambers. Said flaps formed chambers are connected to a chain, said chain is connected to one or more tread wheels;

The force exerted by the pressurized air on the flaps formed chambers generates movement of the flaps formed chambers and the chain, said movement is transformed into rotational movement of the one or more tread wheels. In another object of the apparatus, the movement of the one or more tread wheels is converted into electrical current.

In another object of the subject matter, the apparatus further comprising a reservoir of pressurized air connected to said container for supplying of pressurized air when said float oscillation is insufficient for the generation of sufficient pressurized air to generate movement of the flaps formed chambers.

In another object of the subject matter, the float is connected to the rigid object by a pivot and the rigid object is a weight. The weight and the one or more pistons may be an air pump. In another object of the subject matter, the pressurized air may be released into the container from an outlet pipe located substantially at the bottom end of said container.

It is another object of the disclosed subject matter to provide an apparatus for generating pressurized air power using motion of a body of water, comprising a float confined within a compartment; said compartment is at least partially located under water level such that said float is moved by the motion of a body of water. The apparatus further comprises at least one air chamber located in the vicinity of the compartment and a rigid object connected to the float, such that movement of the float generates movement of the rigid object; said rigid object is further connected to at least one piston. Vertical movement of the rigid object caused by the motion of the body of water moving the float generates vertical movement of the at least one piston that pressurizes the air inside the at least one air chamber.

In another object of the subject matter, the apparatus further comprising at least one outlet pipe connected to the at least one air chamber for conveying the pressurized air. In another object of the subject matter, the apparatus further comprising at least one valve for controlling airflow from the at least one air chamber to the at least one outlet pipe.

In another object of the subject matter, the apparatus further comprising at least one tread wheel, wherein the exit point of the at least one outlet pipe is located in the vicinity of the at least one tread wheel, such that the tread wheel rotates as a result of the pressurized air movement forced towards water level.

In another object of the subject matter, the apparatus further comprising at least one element for limiting the float's movement to vertical movement. In another object of the subject matter, the at least one air chamber is mounted on the compartment. In another object of the subject matter, the apparatus further comprising an at least one movement restriction element for limiting the movement of the float or the rigid object.

It is another object of the disclosed subject matter to provide an apparatus for generating energy using pressurized air, comprising at least one tread wheel and at least one flap formed chamber connected to the at least one tread wheel. At least a portion of the at least one flap formed chamber is located under water level and maneuverable by pressurized air conveyed under water level.

In another object of the subject matter, at least one tread wheel is an at least two tread wheels. The apparatus may further comprise a barrier located between the at least two tread wheels. In another object of the subject matter, the apparatus further comprising a chain connecting the at least one tread wheel and to the at least one flap formed chamber. In another object of the subject matter, the apparatus further comprises an at least one air container storing the pressurized air.

In another object of the subject matter, the apparatus further comprising an at least two pipes and a control unit; at least one pipe is connected to the air chamber having a piston pumped because of waves and another pipe is connected to the container storing the pressurized air. In another object of the subject matter, the apparatus further comprising a container containing water or other liquid.

In another object of the subject matter, a power generator is connected to a horizontal axis rotating because of the movement of the flaps formed chambers; said power generator rotates because of the rotational movement of the horizontal axis and generates electricity thereof.

It is another object of the disclosed subject matter to provide a method of producing electrical energy. The method comprising generating pressurized air in an at least one air chamber using a substantially vertical movement of a float and at least one piston; releasing the pressurized air into a container partially filled with a fluid, said container comprises at least one flaps formed chambers, the flaps formed chamber are connected by a chain; whereby the at least one flaps formed chamber move within the container generating a rotation of the axis.

In another object of the subject matter, the chain is connected to an axis through at least one tread wheel. In another object of the subject matter, the method further comprising a step of generating rotational movement of an at least one tread wheel connected to the one or more flaps formed chambers by a chain. The chain may be chain is connected to an axis through at least one tread wheels.

In another object of the subject matter, the method further comprises a step of generating electricity from the rotational movement of the axis.

### BRIEF DESCRIPTION OF THE DRAWINGS

Exemplary non-limited embodiments of the disclosed subject matter will be described, with reference to the following description of the embodiments, in conjunction with the figures. The figures are generally not shown to scale and any sizes are only meant to be exemplary and not necessarily limiting. Corresponding or like elements are designated by the same numerals or letters.

FIG. 1 schematically illustrates an apparatus for pressurizing air using waves in a downward state, according to an exemplary embodiment of the subject matter;

FIG. 2 schematically illustrates an apparatus for pressurizing air using waves in an upward state, according to an exemplary embodiment of the subject matter;

FIG. 3 describes air chambers and a piston that pressurizes the air within the air chamber, according to an exemplary embodiment of the subject matter;

FIG. 4 schematically illustrates a system for producing electrical power using pressurized air, according to an exemplary embodiment of the subject matter;

FIG. 4A illustrates a lateral view of the system for converting the kinetic energy of the paddles moving around the tread wheels into electrical power, according to an exemplary embodiment of the subject matter;

FIG. 4B illustrates the system for converting the kinetic energy of the tread wheels into electrical power, according to an exemplary embodiment of the subject matter; and,

FIG. 5 shows an environment for efficiently utilizing systems for producing electronic power using waves in accordance with an exemplary embodiment of the subject matter.

### DETAILED DESCRIPTION OF THE PREFERRED EMBODIMENT

The technical problem solved in the disclosed subject matter is to provide a system and method for utilizing pressurized air, a cheap, available and efficient resource, when producing electrical power using waves generated by a body of water, such as an ocean, sea or the like.

One solution disclosed in the subject matter is a system comprising a float oscillating by the movement of a body of water. Such oscillation can be generated by waves or other motion of water or like fluids. The oscillation frequency is determined by the periodic movement of the body of water. The float is preferably restricted to substantially a vertical movement and connected by a pivot to a rigid object such as a weight. The weight is connected to one or more pistons. The weight presses the one or more pistons, preferably located at the upper portion on an air chamber, such that when the one or more pistons are pressed, air in the air chamber is pressurized. The pressurized air is conveyed to a container. Said container is partially filled with water or another fluid. The container is sufficiently large to generate a high hydrostatic pressure at the bottom end thereof. The air is released from an outlet pipe located at the bottom end of the container or in the vicinity thereof. The hydrostatic pressure applied on the pressurized air forces the air rise to the upper portion of said container. The pressurized air is released into flaps formed chambers connected to a chain, said chain connected to one or more tread wheels. The force exerted by the rising pressurized air on said flaps formed chambers generates movement of the flaps formed chambers and the chain. Said movement is transformed into rotational movement of the one or more tread wheels. The movement of the one or more tread wheels is converted into electrical current.

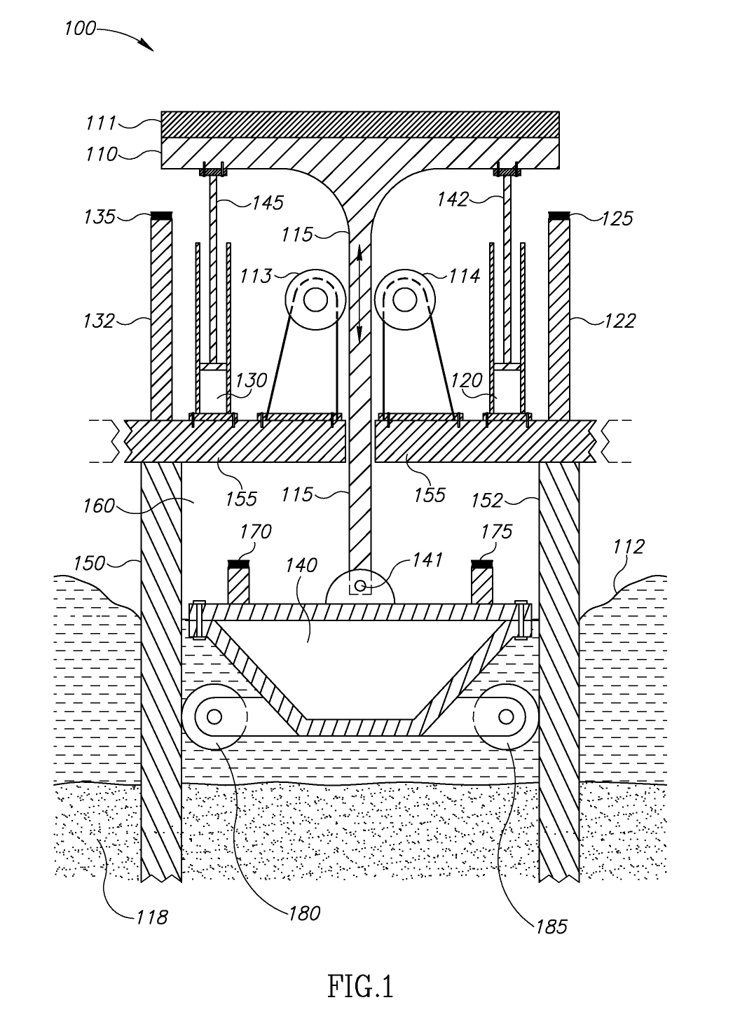

FIG. 1 schematically illustrates an apparatus 100 for pressurizing air using waves or the motion of a body of water, according to an exemplary embodiment of the subject matter. In accordance with an exemplary embodiment of the present subject matter, the apparatus 100 is preferably operated in proximity to a body of water sufficient to generate oscillation such that a float changes its position relative to a structure comprising polls preferably embedded in the waterbed 118. The apparatus shown in FIG. 1 is in a downward state, in which the float 140 moves downwards by the motion of waves and the rigid object 110 connected thereto moves downwards and push pistons 142, 145 in a general downward direction into air chambers 120, 130.

Apparatus 100 comprises a float 140 connected to a rigid surface 110 by a rod 115. In some embodiments of the present invention, rigid surface 110 further comprises a weight 111, which can be made of a concrete slab, iron sheets or other substances, which can provide additional weight to counter the motion of rod 115. Rod 115 is preferably connected to float 140 through a pivot 141. Float 140 is moved in a substantial lateral motion by the oscillation of the body of water 112. Float 140 is preferably located within an area 160 substantially below deck 155 and limited to substantial vertical movement by polls 150, 152. Deck 155 is supported by one or more polls 150, 152. In alternative embodiments, movement of float 140 is restricted by rails, or other limiters, which allow substantial vertical motion. One or more pistons 142, 145, placed in air chambers 120, 130 are connected to the bottom part of rigid object 110. The pistons 142, 145 and air chambers 120, 130 can function for example as air pumps. Air chambers 120, 130 can be placed on the upper end of deck 155. In other exemplary embodiments of the subject matter, the air chambers 120, 130 are placed at any position substantially below the rigid object 110. The downward movement of the float 140 connected to the rigid object 110 pushes downwards pistons 142, 145 connected to air chambers 120, 130. The pushed pistons 142, 145 increase the level of pressure in the air chambers 120, 130. As noted, in an exemplary embodiment, the pistons 142, 145 may also function as an air pump, moved downwardly by rigid object 110 and presses air in air chambers 120, 130. FIG. 1 shows the state when pistons 142, 145 are pushed down and air in air chambers 120, 130 is pressurized. In some embodiments of the present subject matter, pistons 142, 145 may be close tolerance piston or double piston or the like. While in close tolerance piston, o-rings are used as valves, such o-rings are not required for the operation of a double piston. The pistons may operate in a four-stroke mode or a two-stroke mode or in any other similar mode achieving efficient compression of air within air chambers 120, 130.

The float 140 may be provided with a material having characteristics that allows movement of the float when the level of water changes, and moves a heavy metal plate such as rigid object 110. The float may be, for example, a concrete plate having a floatation material there within, or include a hall and optionally a suitable ballast. The float can have a round shape. Floats are commercially available and one exemplary float is disclosed in European patent serial number 1342916B1, titled “ENERGY GENERATING SYSTEM USING SEA WAVES” issued to Arlas Invest, the content of which is incorporated herein by reference. In accordance with some exemplary embodiments of the present subject matter, the float would have a buoyancy of 55 metric tons, while the entire weight of the moving parts of the apparatus would be metric 50 gross tons. This represents an about ten percent (10%) buoyancy for the moving parts of apparatus 100.

In an exemplary embodiment, area 160 is partially located above water level 112 such that one or more air chambers 120, 130 are mounted on the upper end of deck 155. When float 140 moves downwardly according to the oscillation of the body of water, which can be generated by waves, rigid surface 110 moves downwardly and pushes pistons 142, 145 that pressurize air in air chambers 120, 130. One or more vertical restriction elements 180, 185 limit the substantial horizontal movement of float 140. Vertical restriction elements 180, 185 limit a substantial horizontal or diagonal movement of rod 115 thus decreasing the redundancy of energy utilized in pushing the pistons of air chambers 120, 130. In the present example, vertical restriction elements 180, 185 are wheels, bearing wheels, chains, rails, or other rolling or skidding elements allowing as little friction as possible while retaining float 140 in a substantial vertical motion while the body of water oscillates and a portion of water passes through the area 160. When water passes through area 160 the float moves substantially in an upward and downward directions. One or more upper movement restriction elements 122, 132 limit the range of movement of rigid object 110 in the downward direction, protecting the one or more pistons 142, 145 and the air chambers 120, 130 from damages likely to be caused by the rigid object 110. Upper movement elements are located on the upper end of deck 155 and preferably adjacent to air chambers 120, 130. Lower movement restriction elements 170, 175 limit the movement of float 140 in area 160 and prevent damages to the inner upper wall of area 160 caused by fast upward movement of float 140. Air bag or rubber element is provided on top of any of the movement restriction elements provided in the apparatus. For example, rubber elements 125, 135 are located on top of upper movement restriction elements 122, 132. The movement restriction elements disclosed in the subject matter are solid and rigid elements, extending from the internal or external polls 150, 152 of the area 160 to a length that fit the range of movement desired for the float 140, the rigid object 110 or the pistons 142, 145. For example, the size of lower movement restriction elements 170, 175 may be a function of the distance between downward or upward state of float 140 of area 160. In some other exemplary embodiments, a sensor (not shown) can be placed to measure the movement of the body of water such that when such movement may cause damage to deck 155, the rod 115 is locked into place.

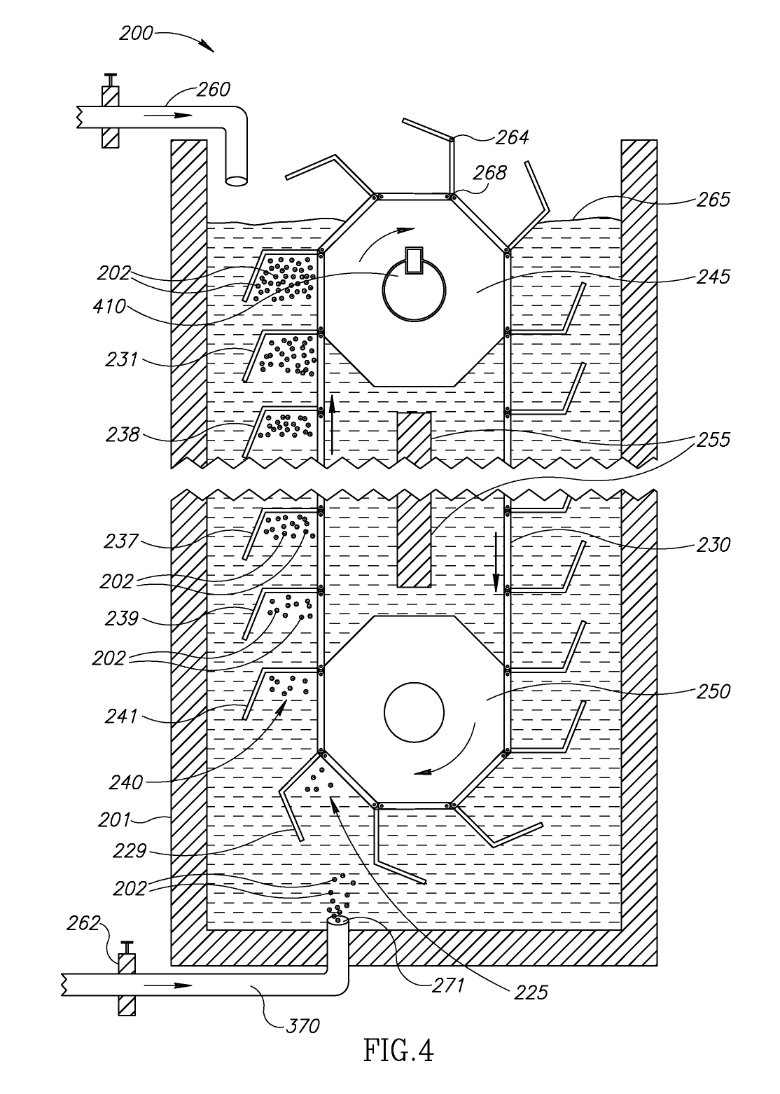

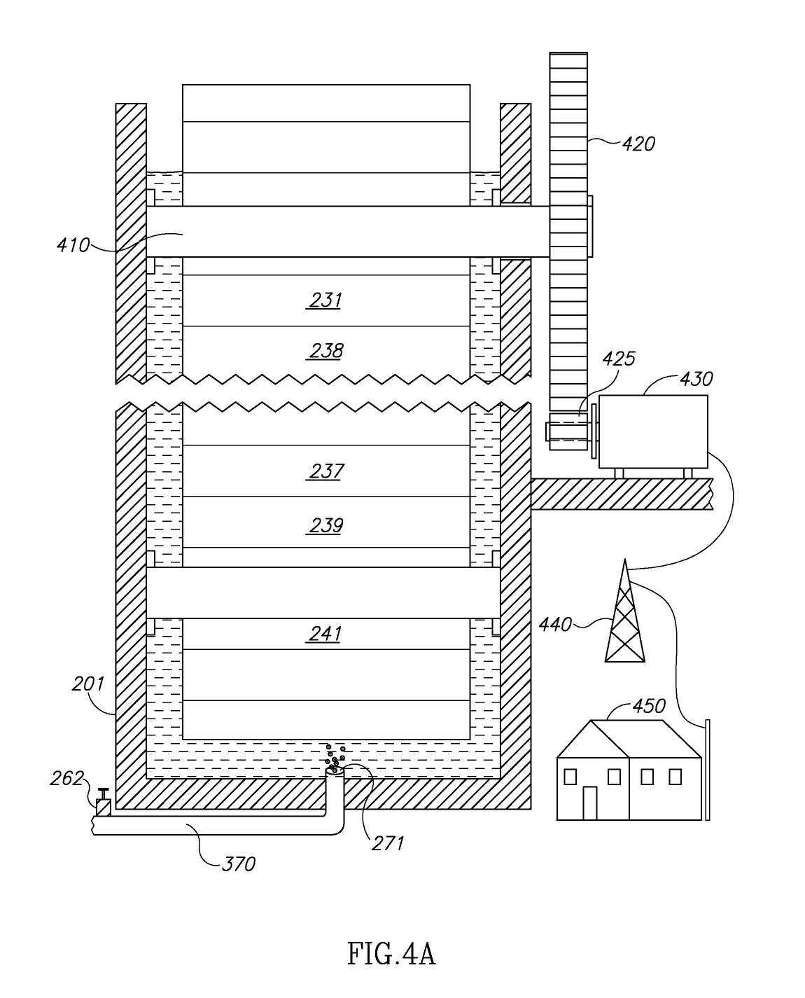

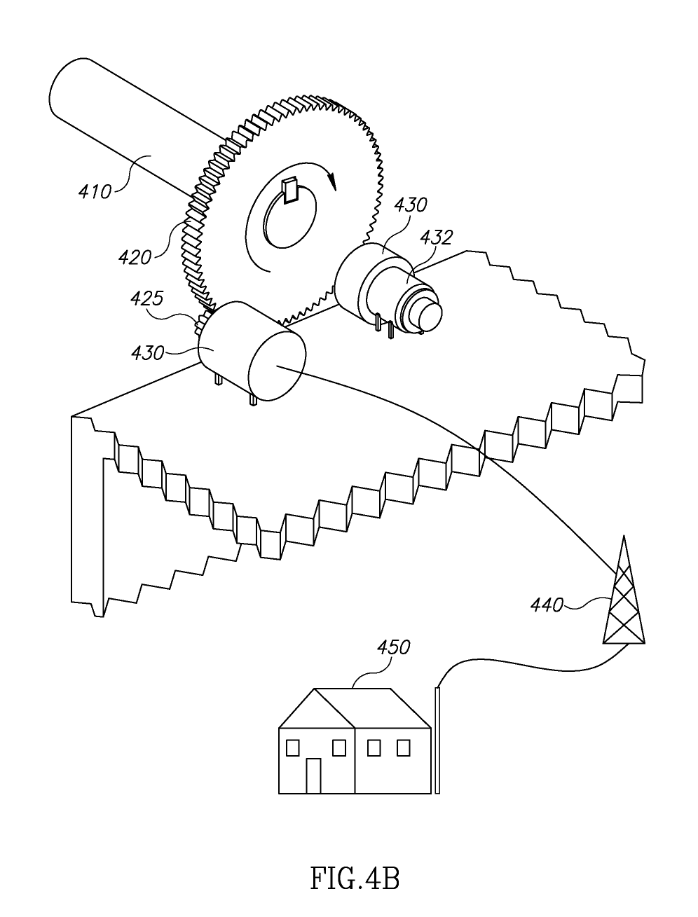

When the level of pressure in air chambers 120, 130 is higher than a predetermined value, such predetermined pressure value can be in accordance with one example between 3 and 6 atmospheres. In some embodiments, the pressure is dependent on the size of container 201 described in further details in association with FIG. 4. The required or best suitable pressure of air is calculated such that the release of air into the apparatus 200 of FIG. 4 would generate optimal force driving the flaps formed chambers 229, 237, 239, 241 of FIG. 4.

In some embodiments, the entire apparatus 100 is below water level 112. In such case, inlet pipes (not shown) are provided to allow air into air chambers 120, 130. Such inlet pipes have a distal end above water level 112 and a proximal end connected to air chambers 120, 130. When at least a portion of the air chambers 120, 130 is located above water level 112, the air flows into the air chambers 120, 130 through an aperture or a unidirectional valve located at the air chambers 120, 130. According to the present embodiment, a membrane (not shown) or a heating device (not shown) may be provided to prevent leakage of fluid into the air chambers 120, 130, for example by vaporizing the fluid in the chamber or filtering the contents within the chambers thus allowing only air within the outlet pipes. In other exemplary embodiments, the entire apparatus, when submerged will be protected and encased within a housing (not shown).

In another embodiment, air chambers 120, 130 are not connected to compartment 160 and float 140 is connected to a third party element that presses pistons that pressurize air in chambers 120, 130. Alternatively, pistons 142, 145 are not connected to rigid object 110. The third party element may be elongated rigid shafts connecting the rigid object and the pistons, or connecting the float 140 to a rigid object located outside the vicinity of compartment 160.

In some embodiments of the present invention, polls 150, 152 of area 160 are preferably vertical and in contact with the waterbed 118 or ground (not shown) on which the apparatus 100 is mounted and secured. Stabilizers 113, 114 are connected to the upper end of deck 155. Stabilizers substantially limit the horizontal movement of rod 115, hence substantially limit the horizontal movement of rigid object 110, such that the efficiency of the movement of float 140 is increased. In some exemplary embodiments of the present invention, stabilizers 113, 114 are wheels attached to a pulley positioned such that sufficient force is applied by the wheels on rod 115 to limit said rod 115 horizontal motion while avoiding to the extent possible friction which would hinder the upward and downward movement of rigid object 110. In other embodiments, stabilizers 113, 114 can also be concrete slabs (not shown) having a rail to accommodate reciprocal track located on said rod 115 to allow smooth and virtually friction free upward and downward movement of rigid object 10 while limiting or eliminating the horizontal movement of rod 115.

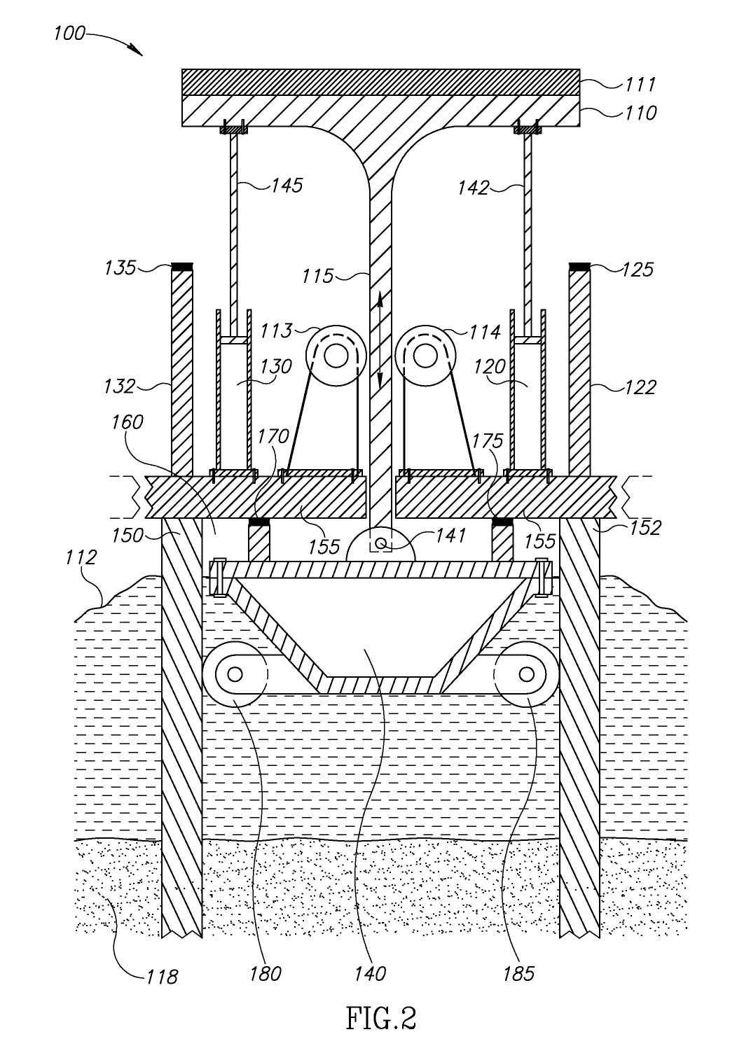

FIG. 2 schematically illustrates the apparatus 100 of FIG. 1 for pressurizing air using a motion of a body of water in an upward state, according to an exemplary embodiment of the subject matter. FIG. 2 discloses the same elements shown in FIG. 1, in the upward state. Referring now to FIG. 2, float 140 moves in an upward direction by the oscillation of the body of water, such as by waves and, as a result, rod 115 and rigid object 110 move in an upward direction. As a result, pistons 142, 145 that are connected to rigid object 110 move in an upward direction and allow air into air chambers 120, 130. The upward movement of float 140 is generally restricted by lower movement restriction elements 170, 175 that is designed to prevent damage to the deck 155 caused by fast upward movement of float 140. Once the wave has receded and level of water 112 decreases the float 140 moves in a downward direction. Thus, rigid object 110 pivotally connected through rod 115 to float 140 moves one or more pistons 142, 145 in a downward direction caused air to pressurize in air chambers 120, 130, as shown in greater detail in FIG. 1.

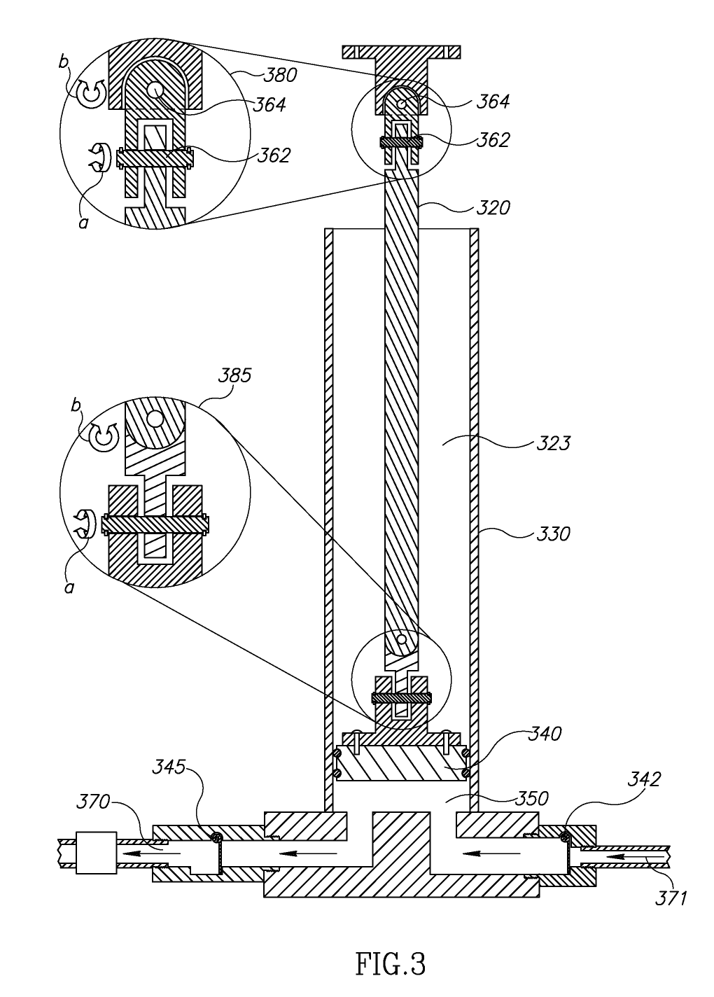

FIG. 3 describes a single air chamber 120, and a piston 320 that pressurizes air within the air chamber, according to an exemplary embodiment of the subject matter. The air chamber 120 is defined by wall 330 and a compressed air chamber 350 in which the air volume to be pressurized or which is pressurized is located. The air chamber 120 can also be a part of an air pump. The shape of air chamber is preferably circular or polygonal, as long as the walls perpendicular to the ground are parallel. Rigid object 110 connected pivotally by rod 115 to float 140 drives piston 320 downwards and, as a result, the volume of air in compressed air chamber 350 is decreased and the air volume is pressurized. In some exemplary embodiments of the present invention, compressed air chamber 350 is also defined by walls 330 and by compressing module 340. Compressing module 340 is the bottom end of piston 320 defined by a circular or polygonal surface that is designed to accommodate substantially the circumference of wall 330 such as not to allow air to escape compressed air chamber 350 when the piston is moved in a downward direction. In some exemplary embodiments of the present invention, compressing module 340 can further include one or more circumferential o-rings located at the upper and lower ends of compressing module 340 or membranes, or sealed metal plate, for allowing smooth movement along walls 330 of piston 320, yet will not allow air to escape compressed air chamber 350. When compressing module 340 is pushed downwards by piston 320, the volume of air in compressed air chamber 350 is decreased and the air in said compressed air chamber 350 is pressurized. To avoid substantial rotational or horizontal movement of rigid object 110, a pivot 362 is provided to connect piston 320 to rigid object 110. Such pivot 362 will provide for movement of rigid object 110 along yaw axis (shown as axis a). In some embodiments, a second pivot 364 is located below and on piston 320 to allow for movement of the rigid object along the roll axis (shown as axis b), thus allowing rigid object 110 to move in all directions without damaging piston 320. A blowup section 380 shows how both pivot 362 and pivot 364 allow for movement of the rigid object 110, and allow for movement of piston 320 as disclosed in the subject matter. In some exemplary embodiments, similar movement can be provided at the bottom end of piston 320 as shown in blowup section 385. The piston 320 may be an air pump, pressurizing air in compressed air chamber 350. Piston 320 is connected to compressing module 340 for decreasing the air volume of compressed air chamber 350. When compressing module 340 is pushed downwards, the size of air volume in chamber 350 decreases, the size of air volume 364 above compressing module 340 is increased and valve 345 opens and allows compressed air to pipe 370. Valve 345 is preferably a unidirectional or a check outlet valve that opens automatically when the level of pressure in volume 350 is higher than the level of pressure outside chamber 350 or at a predetermined pressure level. One such exemplar pressure for allowing valve 345 to be opened is at least 4 atmospheres. Persons skilled in the art will appreciate that any other pressure level sufficient to generate movement of the flap formed chambers described in more details in FIG. 4 would allow the present subject matter to be practiced while achieving one or more objects of the present subject matter. In other alternative exemplary embodiments of the present subject matter, valve 345 is controlled by a control unit and opened either mechanically or electronically according to a command from the control unit. In some exemplary embodiments of the present invention, two unidirectional or check valves are provided in compressed air chamber 350. In accordance with this embodiment, the two or more valves are inlet valve 342 for enabling air into the compressed air chamber 350 and outlet valve 345 for allowing air outside the compressed air chamber 350. Preferably, inlet valve 342 is positioned between inlet pipe 371 and compressed air chamber 350. In an alternative embodiment inlet valve 342 connects inlet pipe 371 and compressed air chamber 350. Preferably, outlet valve 345 is positioned between outlet pipe 370 and compressed air chamber 350. In an alternative embodiment outlet valve 345 connects outlet pipe 370 and compressed air chamber 350.

The size of air chamber 120 may vary according to the amount and level of pressure required for maneuvering a flap formed chamber as further disclosed in association with the description of FIG. 4.

Each air chamber may also comprise a detecting element, such as a pressure sensor, for detecting the level of pressure in the compressed air chamber 350. Alternatively, the detecting element may detect the size of air volume in compressed air chamber 350 or the distance of compressing module 340 from the bottom end of compressed air chamber 350 or from the top end of walls 330. When the level of pressure or another detected value is higher than a predetermined value, the control unit commands opening of outlet valve 345, or opening of inlet valve 342, or a combination thereof suitably timed to allow smooth operation of the piston 120. Pipe 370 is connected to a system for producing power using pressurized air, which is described herein below in association with following figures.

FIG. 4 schematically illustrates a system for producing kinetic power using pressurized air designated 200, in accordance with a preferred embodiment of the present subject matter. The system 200 is preferably located within a container 201 substantially full of water or another liquid or fluid (low density). The container 201 can be located near or remotely from apparatus 100 of FIG. 1. An apparatus containing flaps formed chambers (229, 231, 238, 237, 239, and 241) are mounted within container 201 and rotate around a plurality of tread wheels 245, 250. While the present drawing shows a limited number of flaps formed chambers, any number of such flaps can be used. Compressed air is suitably released from pipe outlet 271 to rise and enter space 225. The flaps formed chambers (229, 231, 238, 237, 239, and 241) are moved along the vertical axis of container 201 towards the water level 265, such movement produces relative expansion of the air within each flap formed chamber. Flaps formed chambers are similar to a cup-like design which encompass a space (such as space 225, 240) in which pressurized air is accumulated and expands as the flaps formed chambers rise through the water column of container 201. As can be noted in FIG. 4, pressurized air 202 rise from pipe outlet 271 towards flap forming chamber 229 and into space 225 currently located above said pipe outlet 271. When pressurized air 202 (within said flap formed chambers) rise inside container 201, their volume increases and additional force is exerted on flap formed chamber 229 resulting in driving of flaps formed chamber 229 in an upward direction until said pressurized air reaches water level 265 and is released from the container 201. As can be seen from FIG. 4, pressurized air 202 expand in volume as it rises through container 201 while driving flaps formed chambers upwards and rotating one or more tread wheels 245, 250 for generating rotational movement from which electricity is produced. When air pressure 202 rises through the water column, it expands with the decrease of hydrostatic pressure. When the air pressure 202 expands, it exerts additional pressure on the flaps formed chambers generating additional force in the upward direction. The system 200 is preferably connected through inlet pipe 370 to apparatus 100, which is generally the apparatus disclosed in FIG. 1. In some other embodiments of the present invention, pressurized air is delivered to inlet pipe 370 from a tank or reservoir of pressurized air, where pressurized air has been previously stored. Persons skilled in the art will appreciate that water level 265 may be higher or lower to achieve maximum rotation and efficiency of the system.

In some embodiments, a chain 230 surrounds one or more tread wheels such as wheels 245, 250 that rotate according to the movement of the flaps formed chambers. Chain 230 is preferably tightened around two or more tread wheels used in system 200, and connected to the flaps formed chambers (231, 238, 237, 239, 241) maneuvered by pressurized air conveyed into water. The chain 230 may further comprise elements such as niches or sockets in which a protruding member of the flaps formed chambers (231, 238, 237, 239, 241) fit for attaching the flaps formed chambers (231, 238, 237, 239, 241) to the chain 230. The chain 230 may be metal or plastic, and may move in an adaptive mechanical track associated with the tread wheels. For example, a mechanical track located in the center of the external wall of each wheel. Other exemplary embodiments of likewise design of chains that propel or move a set of flaps formed chambers (231, 238, 237, 239, 241) within a chamber substantially full or water will be evident to those persons skilled in the art.

The container 201 is preferably used in case the system 200 is located on land, instead of in a body of water. As noted above, the movement of flaps formed chambers (231, 238, 237, 239, 241) is generated by pressurized air conveyed from apparatus 100 disclosed in FIGS. 1 and 2 or a suitable reservoir of pressurized air. In the disclosed subject matter, one or more pipes convey pressurized air into the space between two flaps formed chambers (231, 238, 237, 239, 241). For example, inlet pipe 370 conveys air from apparatus 100 into flap formed space 240 located under flap formed chamber 241. Alternatively, pipe outlet 271 conveys pressurized air from an air container (not shown) which stores pressurized air that was previously pressurized using the motion of waves or through the use of an air pump driven by another mechanism. The air container (not shown) may be used when the movement of water do not provide sufficient lateral motion to enable generating sufficient air pressure by apparatus 100. A detecting element, such as a sensor, may be provided to detect the amount of movement of the float 140, motion of body of water, the height of the waves and other parameters. Such detecting element sends a command to a control unit within the air container (not shown) to provide additional compressed air in case the detected parameters is lower than a predetermined value.

Paddle-like walls define the flap formed space 240 within the flap formed chamber in five of six directions, such that the open portion of the container-like space in which air may enter flap formed space 240 points downward when the flaps formed chambers (231, 238, 237, 239, 241) move upwards. When the compressed air 202 is conveyed out of outlet pipe 370, the pressure of the said pressurized air is forced upwards. In one exemplary non-limiting embodiment of the present subject matter, in a 40-meter high container 201, in case the pressure of the pressurized air 202 is about or more than four atmospheres, the pressurized air pushes the flaps formed chambers (231, 238, 237, 239, 241) upwardly because of the pressure loss and the reduction of hydrostatic pressure as the pressurized air ascends. Since the air is pressurized and provided in a specific depth, the air is forced upwards and expands. Hence, the volume of the air provided in flap formed space 240 is significantly larger when the same amount of air is in the depth of flap formed space 225.

In some embodiments of the present subject matter a water or other liquid tap 260 for allowing water or other liquid into container 201. In addition, in some embodiments, a pressure valve 262 is located along pipe 370 to regulate the compression pressure of the air passing through pipe 370 to allow for release of air at a predetermined pressure at pipe outlet 271. Pressure valve 262 can also be used to discontinue the flow of pressurized air into container 201 through an to appropriate controller (not shown).

In an alternative embodiment, at least a portion of the flaps formed chambers (231, 238, 237, 239, 241) are located above sea level and maneuvered by pressurized air from the pipes. The force exerted by expanding air volume on the flaps formed chambers generate movement of the said flaps formed chambers (231, 238, 237, 239, 241) and kinetic energy is generated through the turning of tread wheals 245, 250. Such kinetic energy may be converted into electrical power in several methods, some of which are shown below. Two tread wheels 245, 250 are connected to a chain carrying the flaps formed chambers (231, 238, 237, 239, 241) clockwise. In some embodiments of the present subject matter, barrier 255 is optionally located between tread wheels 245, 250 for allowing the movement of water in the upward and downward directions. Barrier 225 may be extended or shortened to allow for efficient movement of the chain 230 carrying the flaps formed chambers (231, 238, 237, 239, 241). At least a portion of the flaps formed chambers (231, 238, 237, 239, 241) are located above water level 265, such that the pressurized air is provided to a space under water level.

In some embodiments of the present invention, two or more outlet pipes are connected to air chambers 120, 130 (FIG. 1) in which the air is compressed. The compressed air is conveyed in the pipes to a plurality of flap formed spaces 240. For example, the number of outlet pipes may be equal to the number of container-like spaces. A control unit for optimizing the efficiency of movement of the flaps formed chambers (231, 238, 237, 239, 241) determines the amount or level of pressure of air conveyed to each space. For example, the amount or the level of pressure of air conveyed to the space between the flaps formed chambers (231, 238, 237, 239, 241) that are relatively closer to sea level is lower than the amount of air conveyed to the space in the lower portion of the container 201.

In other embodiments of the disclosed subject matter, the pressurized air from various chambers is conveyed by one pipe. As a result, more air with a higher pressure level may be conveyed when a unidirectional valve located near the outlet of the air chamber opens, generate more pressure between flaps formed chambers (231, 238, 237, 239, 241), force the flaps formed chambers upwards and eventually enable generation of rotational movement. Alternatively, more than one pipe is used; each pipe is connected to one or more chambers. The compressed air may be stored in the pipes for a predetermined period of time.

FIG. 4A illustrates a lateral view of the system for converting the kinetic energy of the flaps formed chambers (231, 238, 237, 239, 241) moving around the tread wheels into electrical power, according to an exemplary embodiment of the subject matter. The figure shows the container 201 containing water or other liquid. Pressurized air released from outlet pipe 271 to the water within container 201 is encased in chambers formed by flaps formed chambers (231, 238, 237, 239, 241). With the expansion of the pressurized air as the hydrostatic pressure is decreased, and as air is buoyant, applying pressure in the upward direction, flaps formed chambers (231, 238, 237, 239, 241) move upwards and in a rotational manner around horizontal axis 410. Since the flaps formed chambers (231, 238, 237, 239, 241) are connected to the axis 410, the rotational movement of flaps formed chambers (231, 238, 237, 239, 241) generates rotational movement of horizontal axis 410. Horizontal axis 410 is connected to wheel 420. Rotational movement of horizontal axis 410 is transferred to wheel 420. In some embodiments of the subject matter, horizontal axis 410 is connected to the center of wheel 420 and positioned perpendicular to the surface of wheel 420. Wheel 420 is connected to secondary wheel 425. Wheel 420 movement is transferred to wheel 425. In an exemplary embodiment of the subject matter, the connection between wheel 420 and secondary wheel 425 is achieved using cogwheels, strap wheels or another mechanism (not shown) that generates movement of the secondary wheel 425 as a result of the movement of the wheel 420. In an exemplary embodiment of the subject matter, secondary wheel 425 is significantly smaller than wheel 420, such that the number of rounds per minute (RPM) of secondary wheel 425 is much higher than the RPM of wheel 420. Secondary wheel 425 is suitably connected to a power-generating element 430 that moves rotationally and generates power. Such power is transmitted to power station 440 and then to the end user 450.

FIG. 4B illustrates one method for converting the kinetic energy of the flaps formed chambers (231, 238, 237, 239, 241) moving around the tread wheels into electrical power, according to an exemplary embodiment of the subject matter. As shown previously, the compressed air conveyed into system 200 of FIG. 2 generates rotational movement of flaps formed chambers (231, 238, 237, 239, 241) around horizontal axis 410. As a result, horizontal axis 410 is rotated around its longitudinal axis. Rotational axis 410 is connected to the center of wheel 420 and positioned perpendicular to wheel 420, such that rotational movement of axis 410 generates rotational movement of wheel 420 connected to horizontal axis 410. The movement of flaps formed chambers (231, 238, 237, 239, 241) generates movement of horizontal axis 410 and wheel 420. As noted in FIG. 4, wheel 420 is connected to secondary wheel 425 to which rotational movement of wheel 420 is transferred. Secondary wheel 425 is connected to a power-generating element 430 that moves rotationally and generates power. Such power generating provided by rotational movement of power-generator is performed in various methods known to a person skilled in the art. Such power is transmitted to power station 440 and then to the end user 450. In some exemplary embodiments of the present subject matter, a starter device 432 is also provided. The initial movement of the chain 230 and the flaps formed chambers (231, 238, 237, 239, 241) may require movement assistance. This because insufficient amount of pressurized is located within flaps formed chambers spaces. The initiation of the system 200 can be performed through the activation of the starter device 432 and transmission of power to the power-generating element 430 that will in turn rotate and generate power that is transferred to the rotation of the chain 230 and flaps formed chambers (231, 238, 237, 239, 241 of FIG. 4) via horizontal axis 410. Once the flaps formed chambers (231, 238, 237, 239, 241) rotate and pressurized air 202 from outlet pipe 271 arrived at water level 265 the starter device 432 can be disengaged and the system 200 will continue operation through the use and flow of pressurized air alone.

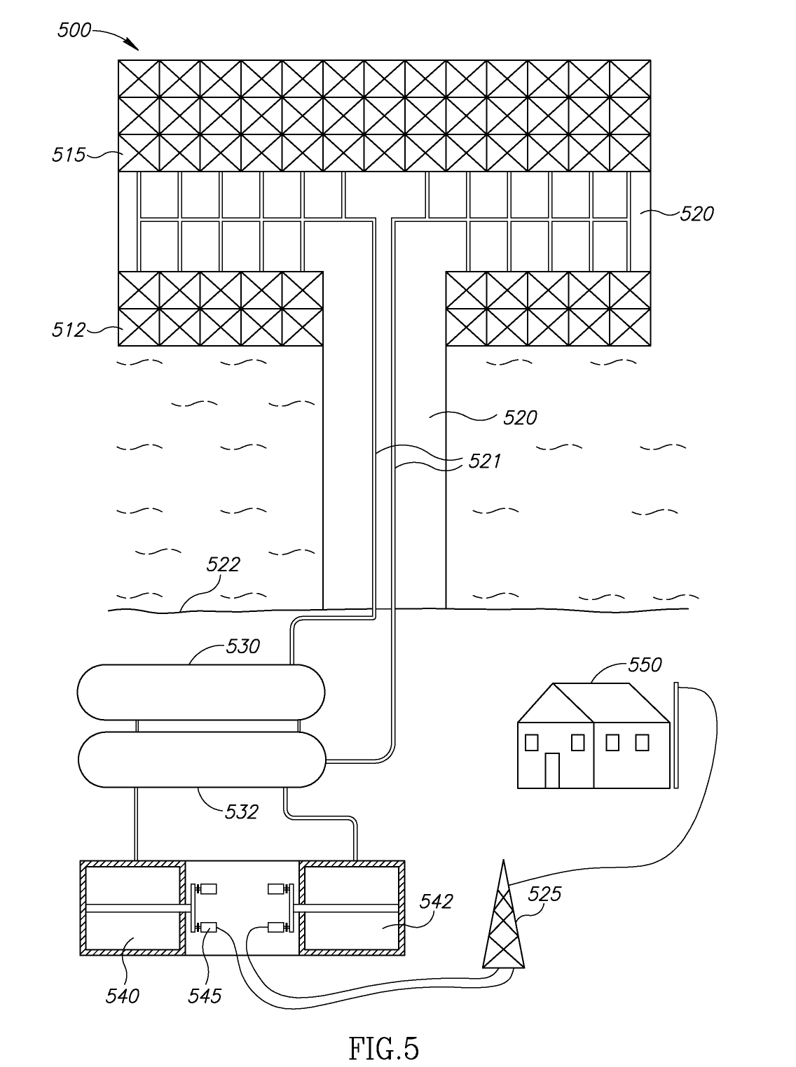

FIG. 5 illustrates an exemplary environment 500 desired for utilizing multiple systems such as described in FIGS. 1 through 4B, for producing electronic power using waves in a body of water, in accordance with an exemplary embodiment of the subject matter. Environment 500 comprises a plurality of systems 512, 515 generating electrical power using pressurized air according to apparatus disclosed in FIGS. 1 through 4B The systems 512, 515 comprise of multiple apparatuses that generate pressurized air in accordance with the teaching of the subject matter. In accordance with some exemplary embodiments, the systems 512, 515 are located at least partially under water level. An access road or bridge connects the plurality of systems 512, 515 with the main land 522. The access road or bridge 520 can be used to transfer pressurized air through suitable pipes 521 to tank 530, 532 or to other elements of the environment 500. The pressurized air from systems 512, 515 may be conveyed to a tank 530, 532 located on land 522 or in the water. Then, the pressurized air conveyed to containers 540, 542 (apparatus 200, described in detail in FIGS. 4, 4A). Tread wheel 245, 250 of FIG. 4 is connected to power-generator 545 that generates power and conveys the power to a power station 525 and then to the end user 550. The transfer of rotational power into electricity is also described in association with FIG. 4B. In an exemplary embodiment, air tank 530 stores and regulates pressurized air from system 512 to containers 540, 542 and air tank 532 is used when the amount of pressurized air from system 512, 515 is under a predetermined value, for example when waves do not provide enough movement for float 140.

While the disclosure has been described with reference to exemplary embodiments, it will be understood by those skilled in the art that various changes may be made and equivalents may be substituted for elements thereof without departing from the scope of the subject matter. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this subject matter, but only by the claims that follow.

1. An apparatus for converting the motion of a body of water to rotational energy comprising:
a float oscillating by the movement of the body of water;
the float is connected to a rigid object;
the rigid object is connected to one or more pistons generating pressurized air in one or more air chambers caused by vertical movement of the float;
a container partially filled with a fluid and interconnected to said pistons through one or more pipes conveying the pressurized air to said container;
the pressurized air is released into one or more flaps formed chambers;
said flaps formed chambers are connected to a chain, said chain is connected to one or more tread wheels;
wherein the force exerted by the pressurized air on the flaps formed chambers generate movement of the flaps formed chambers and the chain, said movement is transformed into rotational movement of the one or more tread wheels.

2. The apparatus of claim 1 wherein the movement of the one or more tread wheels is converted into electrical current.

3. The apparatus of claim 1 further comprising a reservoir of pressurized air connected to said container for supplying of pressurized air when said float oscillation is insufficient for the generation of sufficient pressurized air to generate movement of the flaps formed chambers.

4. The apparatus of claim 1 wherein the float is connected to the rigid object by a pivot and the rigid object is a weight.

5. The apparatus of claim 4 wherein the weight and the one or more pistons are an air pump.

6. The apparatus of claim 1 wherein the pressurized air is released into the container from an outlet pipe located substantially at the bottom end of said container.

7. An apparatus for generating pressurized air power using motion of a body of water, comprising:
a float confined within a compartment; said compartment is at least partially located under water level such that said float is moved by the motion of a body of water;
at least one air chamber located in the vicinity of the compartment;
a rigid object connected to the float, such that movement of the float generates movement of the rigid object; said rigid object is further connected to at least one piston;
wherein vertical movement of the rigid object caused by the motion of the body of water moving the float generates vertical movement of the at least one piston that pressurizes the air inside the at least one air chamber.

8. The apparatus according to claim 7, further comprising at least one outlet pipe connected to the at least one air chamber for conveying the pressurized air.

9. The apparatus according to claim 7, further comprising at least one valve for controlling airflow from the at least one air chamber to the at least one outlet pipe.

10. The apparatus according to claim 7, further comprising at least one tread wheel, wherein the exit point of the at least one outlet pipe is located in the vicinity of the at least one tread wheel, such that the tread wheel rotates as a result of the pressurized air movement forced towards water level.

11. The apparatus according to claim 7, further comprising at least one element for limiting the float's movement to vertical movement.

12. The apparatus according to claim 7, wherein the at least one air chamber is mounted on the compartment.

13. The apparatus according to claim 7, further comprising an at least one movement restriction element for limiting the movement of the float or the rigid object.

14. An apparatus for generating energy using pressurized air, comprising:
at least one tread wheel;
at least one flap formed chamber connected to the at least one tread wheel;
wherein at least a portion of the at least one flap formed chamber is located under water level and maneuverable by pressurized air conveyed under water level.

15. The apparatus according to claim 14, wherein the at least one tread wheel is an at least two tread wheels.

16. The apparatus according to claim 14, further comprising a barrier located between the at least two tread wheels.

17. The apparatus according to claim 14, further comprising a chain connecting the at least one tread wheel and to the at least one flap formed chamber.

18. The apparatus according to claim 14, further comprises an at least one air container storing the pressurized air.

19. The apparatus according to claim 14, further comprising the apparatus of claim 7.

20. The apparatus according to claims 19, further comprising an at least two pipes and a control unit; at least one pipe is connected to the air chamber having a piston pumped because of waves and another pipe is connected to the container storing the pressurized air.

21. The apparatus according to claim 14, further comprising a container containing water or other liquid.

22. The apparatus according to claim 14, wherein a power generator is connected to a horizontal axis rotating because of the movement of the flaps formed chambers; said power generator rotates because of the rotational movement of the horizontal axis and generates electricity thereof.

23. A method of converting the motion of a body of water to rotational energy comprising:
generating pressurized air in an at least one air chamber using a substantially vertical movement of a float and at least one piston;
releasing the pressurized air into a container partially filled with a fluid, said container comprises at least one flaps formed chambers, the flaps formed chamber are connected by a chain;
whereby the at least one flaps formed chamber move within the container generating a rotation of the axis.

24. The method according to claim 23, wherein the chain is connected to an axis through at least one tread wheels.

25. The method according to claim 25, further comprises the step of generating electricity from the rotational movement of the axis.
